(19) United States
(12) Patent Application Publication
(10) Pub. No.: US 2025/0166285 A1
(43) Pub. Date: May 22, 2025

(54) METHODS AND SYSTEMS FOR ADAPTIVE RAY-CASTING OF 3D SCALAR FIELDS ON WIDE SIMD MACHINE

(71) Applicant: FOVIA, INC., Palo Alto, CA (US)

(72) Inventor: Georgiy BUYANOVSKIY, Palo Alto, CA (US)

(21) Appl. No.: 18/954,141

(22) Filed: Nov. 20, 2024

Related U.S. Application Data
(60) Provisional application No. 63/601,472, filed on Nov. 21, 2023.

(51) Int. Cl. G06T 15/06; G06T 15/00

(52) U.S. Cl. CPC G06T 15/06; G06T 15/005

(57) ABSTRACT

An adaptive ray-casting of 3D scalar fields on a wide SIMD machine process and system is described. In one example, a process initially casts/renders rays through a 3D scalar field to acquire information associated with specific properties of this 3D scalar field. The acquired information is then stored on a 2-D image plane. Each pixel on this 2D image plane represents the result of ray casting through the 3-D scalar field. The process of non-even/non-uniform/adaptive samplings along each ray aims/intends to minimize the number of samplings to obtain/acquire the most accurate approximation of the information of interest, doing that effectively on a wide SIMD machine.

### CROSS-REFERENCE TO RELATED APPLICATIONS

This application claims priority to U.S. Provisional Application No. 63/601,472, entitled “METHODS AND SYSTEMS FOR ADAPTIVE RAY-CASTING OF 3D SCALAR FIELDS ON WIDE SIMD MACHINE,” filed on Nov. 21, 2023, which is hereby incorporated by reference in its entirety.

### FIELD

The present invention relates generally to volumetric ray casting, and more particularly, to a method and system for rendering a 3D scalar field to acquire the maximum value of the 3D scalar field along the ray, to compute its average along the ray, to compute the same but weighted by the ray traversal distances from the source, and/or to compute a rendering integral along the ray for a given transfer function.

### BACKGROUND

Visualization of the internal structure of 3-D objects on a 2-D image is an important topic within the field of computer graphics and has been applied to many industries, including medicine, geoscience, manufacturing, and drug discovery.

For example, a CT scanner can produce hundreds or even thousands of parallel 2-D image slices of a patient's body including different organs, e.g., a heart, each slice including a 2-D array of data values and each data value representing a scalar attribute of the body at a particular location, e.g., density. All the slices are stacked together to form an image volume or a volumetric dataset of the patient's body with the heart embedded therein. A 2-D image showing the 3-D structural characteristics of the heart is an important aid in the diagnosis of cardiovascular disease. As another example, the oil industry uses seismic imaging techniques to generate a 3-D image volume of a 3-D region in the earth. Some important geological structures, such as faults or salt domes, may be embedded within the region and not necessarily on the surface of the region. Similarly, a 2-D image that fully reveals the 3-D characteristics of these structures is critical in increasing oil production.

Direct volume rendering is a technique developed for visualizing the interior of a solid region represented by a 3-D image volume on a 2-D image plane, e.g., a computer monitor. Typically, the scalar attribute or voxel at any point within the image volume is associated with a plurality of optical properties, such as color or opacity, which can be defined by a set of lookup tables. The 2-D image plane consists of a regularly spaced grid of picture elements or pixels, each pixel having red, green, and blue color components. A plurality of rays are cast from the 2-D image plane into the volume and they are attenuated or reflected by the volume. The amount of attenuated or reflected ray energy of each ray is indicative of the 3-D characteristics of the objects embedded within the image volume, e.g., their shapes and orientations, and further determines a pixel value on the 2-D image plane in accordance with the opacity and color mapping of the volume along the corresponding ray path. The pixel values associated with the plurality of ray origins on the 2-D image plane form an image that can be rendered on a computer monitor. A more detailed description of direct volume rendering is described in “Computer Graphics Principles and Practices” by Foley, Van Dam, Feiner and Hughes, 2nd Edition, Addison-Wesley Publishing Company (1996), pp 1134-1139.

Returning to the CT example discussed above, even though a doctor can arbitrarily generate 2-D image slices of the heart by intercepting the image volume in any direction, no single image slice is able to visualize the whole surface of the heart. In contrast, a 2-D image generated through direct volume rendering of the CT image volume can easily reveal the 3-D characteristics of the heart, which is very important in many types of cardiovascular disease diagnosis. Similarly in oil exploration, direct volume rendering of 3-D seismic data has proved to be a powerful tool that can help petroleum engineers to determine more accurately the 3-D characteristics of geological structures embedded in a region that are potential oil reservoirs and to increase oil production significantly.

Even though direct volume rendering plays a key role in many important fields, there are several technical challenges that need to be overcome to assure wide deployment of the direct volume rendering technique. First, direct volume rendering is a computationally expensive process. In order to produce a high quality 2-D image that can capture the 3-D characteristics of a 3-D target, direct volume rendering needs to process a large 3-D dataset, which usually means a large number of calculations. For example, it requires at least 140 million calculations to generate a 2-D image of 5122 pixels for a typical 3-D dataset of 5123 voxels using conventional direct volume rendering algorithms.

Given the limited computational capacity of any computers, more efficient algorithms have been developed to reduce the computational cost of direct volume rendering. However, many of these algorithms achieve their efficiency by sacrificing the quality of the generated 2-D images. For example, a common problem with discrete representation of a continuous object is the jitter effect, which is most obvious when a user zooms in to view more details of the continuous object. If the jitter effect is not carefully controlled, it may significantly corrupt the quality of an image generated by a direct volume rendering algorithm.

Therefore, it would be desirable to develop a new direct volume rendering method and system that increases the rendering efficiency while having less or preferably imperceptible impact on the image quality.

### SUMMARY

In one aspect, an exemplary adaptive ray casting system is provided. The exemplary ray casting system includes a Singe Instruction Multiple Data (SIMD) processing unit and memory, the memory storing instructions for executing a shader (e.g., to cast rays through a 3D scaler field) and acquiring information in a vicinity of each sample point along a ray (to acquire information associated with specific properties of the 3D scaler field). The instructions further include computing a ray casting process based on the acquired information, determining a step-length size to the next sample point along the ray, and rendering at least a portion of an image for display based on the acquired information and the ray casting process.

In some examples, the step-length size and/or acquired information is applied to weight each sample contribution to the ray casting process. In some examples, the step-length size and/or acquired information is applied as a parameter to adjust one or more computations associated with the ray casting process. The system may further include instructions for modulating the step-length size or the information used to derive step-length size for adjusting precision of the ray casting process.

In other aspects, exemplary processes for adaptive ray casting and exemplary computer-readable storage medium for carrying out the process are provided. The exemplary ray casting process includes executing a shader (e.g., to cast rays through a 3D scaler field) and acquiring information in a vicinity of each sample point along a ray (to acquire information associated with specific properties of the 3D scaler field). The process further includes computing a ray casting process based on the acquired information, determining a step-length size to the next sample point along the ray, and rendering at least a portion of an image for display based on the acquired information and the ray casting process.

### FIGURES

FIG. 1 illustrates an exemplary system for ray-casting 3D images.

FIG. 2 illustrates an exemplary process for ray-casting 3D images.

FIGS. 3A-3C illustrate exemplary renderings of ray-casted 3D images according to various examples described herein.

### DETAILED DESCRIPTION

As described herein, exemplary processes, systems, and computer-readable storage medium for adaptive ray-casting of 3D scalar fields on a wide Singe Instruction Multiple Data (SIMD) machine are provided. In one example, a process initially casts/renders rays through a 3D scalar field to acquire information associated with specific properties of this 3D scalar field. The acquired information is then stored on a 2-D image plane. Each pixel on this 2D image plane represents the result of ray casting through the 3-D scalar field. The process of non-even/non-uniform/adaptive samplings along each ray aims/intends to minimize the number of samplings to obtain/acquire the most accurate approximation of the information of interest, doing that effectively on a wide SIMD machine.

Various embodiments described herein may be carried out by computer devices, medical imaging systems, and computer-readable non-transitory storage medium comprising instructions for carrying out the described methods.

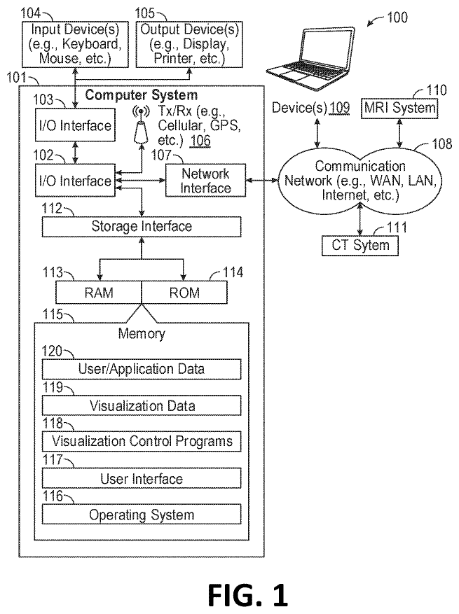

FIG. 1 illustrates an exemplary system 100 for ray-casting 3D images, consistent with some examples described herein. System 100 may include a computer system 101, input devices 104, output devices 105, devices 109, Magnet Resonance Imaging (MRI) system 110, and Computer Tomography (CT) system 111 (of course, other systems and data, such as seismic, geo-physical, seismic imaging, and the like may be included and/or used) with exemplary system 100. It is appreciated that one or more components of system 100 can be separate systems or can be integrated systems. In some embodiments, computer system 101 may comprise one or more central processing units (“CPU” or “processor(s)”) 102. Processor(s) 102 may comprise at least one data processor (including e.g., a SIMD machine) for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor 102 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor(s) 102 may be disposed in communication with one or more input/output (I/O) devices via I/O interface 203. I/O interface 103 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 103, computer system 101 may communicate with one or more I/O devices. For example, input device 104 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, electrical pointing devices, etc. Output device 105 may be a printer, fax machine, video display (e.g., cathode ray tube (CRT), liquid crystal display (LCD), light-emitting diode (LED), plasma, or the like), audio speaker, etc. In some embodiments, a transceiver 106 may be disposed in connection with the processor(s) 102. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor(s) 102 may be disposed in communication with a communication network 108 via a network interface 107. Network interface 107 may communicate with communication network 108. Network interface 107 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 108 may include, without limitation, a direct interconnection, local area network (LAN), wide area network (WAN), wireless network (e.g., using Wireless Application Protocol), the Internet, etc. Using network interface 107 and communication network 108, computer system 101 may communicate with devices 109. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer system 101 may itself embody one or more of these devices.

In some embodiments, using network interface 107 and communication network 108, computer system 101 may communicate with MRI system 110, CT system 111, or any other medical imaging systems. Computer system 101 may communicate with these imaging systems to obtain images for display. Computer system 101 may also be integrated with these imaging systems.

In some embodiments, processor 102 may be disposed in communication with one or more memory devices (e.g., RAM 213, ROM 214, etc.) via a storage interface 112. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, flash devices, solid-state drives, etc.

The memory devices may store a collection of program or database components, including, without limitation, an operating system 116, user interface 117, medical visualization program 118, visualization data 119 (e.g., tie data, registration data, colorization, etc.), user/application data 120 (e.g., any data variables or data records discussed in this disclosure), etc. Operating system 116 may facilitate resource management and operation of computer system 101. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 117 may facilitate display, execution, interaction, manipulation, or operation of program components through textual or graphical facilities. For example, user interfaces may provide computer interaction interface elements on a display system operatively connected to computer system 101, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, computer system 101 may implement medical imaging visualization program 118 for controlling the manner of displaying medical scan images. In some embodiments, computer system 101 can implement medical visualization program 118 such that the plurality of images are displayed as described herein.

In some embodiments, computer system 101 may store user/application data 120, such as data, variables, and parameters (e.g., one or more parameters for controlling the displaying of images) as described herein. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

It should be noted that, despite references to particular computing paradigms and software tools herein, the computer program instructions with which embodiments of the present subject matter may be implemented may correspond to any of a wide variety of programming languages, software tools and data formats, and be stored in any type of volatile or nonvolatile, non-transitory computer-readable storage medium or memory device, and may be executed according to a variety of computing models including, for example, a client/server model, a peer-to-peer model, on a stand-alone computing device, or according to a distributed computing model in which various of the functionalities may be affected or employed at different locations. In addition, references to particular algorithms herein are merely by way of examples. Suitable alternatives or those later developed known to those of skill in the art may be employed without departing from the scope of the subject matter in the present disclosure.

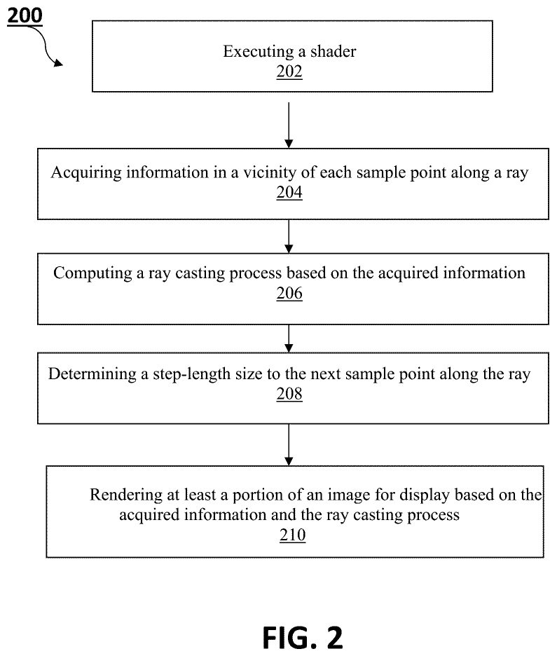

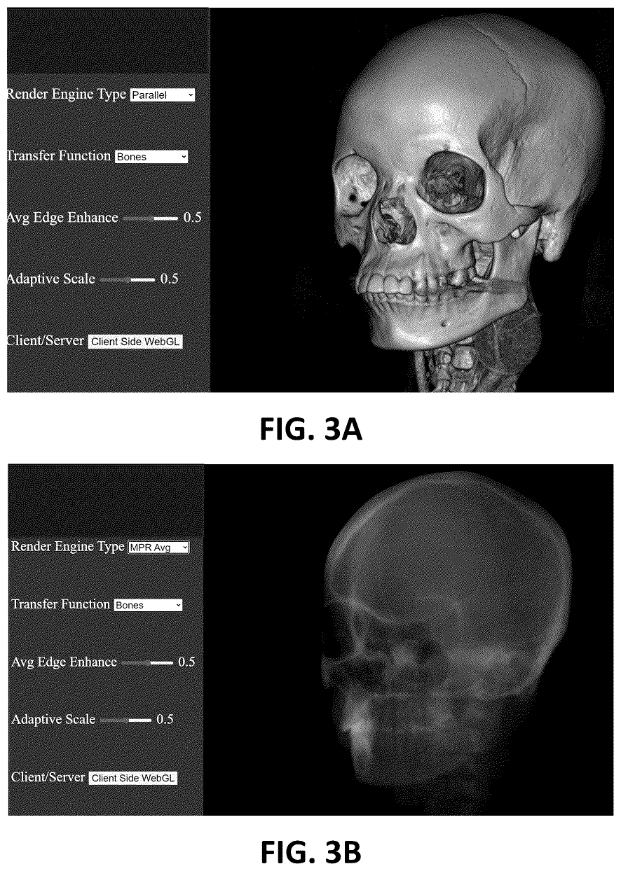

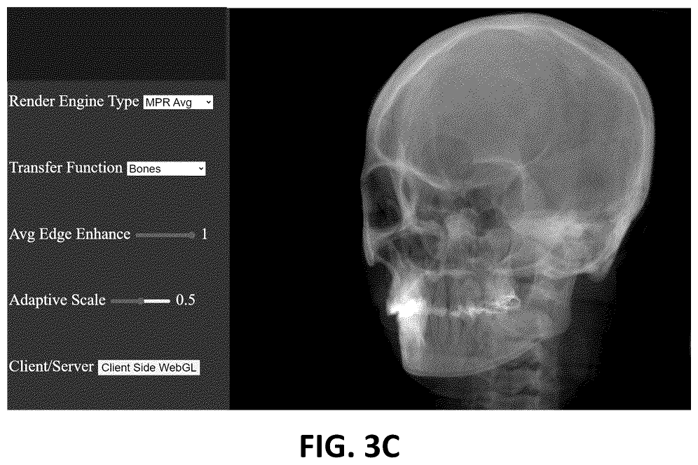

FIG. 2 illustrates an exemplary process 200 for ray-casting 3D images. In particular, the exemplary process includes executing a shader 202 (e.g., to cast rays through a 3D scaler field as further described below) and acquiring information in a vicinity of each sample point along a ray 204 to acquire information associated with specific properties of the 3D scaler field. Process 200 further includes computing a ray casting process based on the acquired information 206, determining a step-length size to the next sample point along the ray 208, and rendering at least a portion of an image for display based on the acquired information and the ray casting process 210, e.g., FIGS. 3A-3C illustrate various examples of images rendered per process 200. As illustrated, adaptive sampling on a SIMD machine as provided herein produces an interactive rate high-fidelity and high-resolution volume rendering images.

In some examples, the process 202 further includes modulating the step-length size or the information used to derive step-length size for adjusting precision of the ray casting process. Further, in some examples, the acquired information 206 in the vicinity of each of the sample points along the ray randomizes the step-lengths across all rays to negate moiré patterns.

The exemplary process 200 will now be described in greater detail. The common approach to increase the process of ray-casting includes subdividing a volume to a hierarchical structure of volume subdivisions with information about the properties of correspondent sub-volumes for each node of this tree. Information about the sub-volume content allows this approach to process each sub-volume faster, e.g., the most trivial case is just to skip a sub-volume if it is empty since it does not contribute to the rendering integral or does not contain the maximum value for Maximum Intensity Projection (MIP). The traversal through such hierarchical structures on Singe Instruction Multiple Data (SIMD) machines is notoriously SIMD unfriendly (though, it does not imply impossible) since SIMD architecture executes a single series/chain of instructions upon wide data arrays while the logic of traversal through such hierarchical structures may yield a very different chain of instructions even for neighboring rays. As such, SIMD machines are generally not particularly well suited for such ray traversal processes.

The SIMD architecture has no restrictions on the fact that the data in the arrays it works with can change their values completely independently of each other. The distance to the next sampling point along the ray is not an instruction it is just a value of some variable. As such, an identical chain of instructions may work with arbitrarily different values of variables representing the step sizes between samplings for multiple rays processed in parallel. Various distributions of samples along a ray do not require a different chain of instructions, so it can be done efficiently on a SIMD machine no matter how wide the SIMD machine. In one exemplary process described herein, the process ensures that the code path does not depend on the sampling distribution along the ray, therefore it is efficient for execution on SIMD machine no matter how wide the SIMD machine.

To ensure a desired accuracy of the exemplary process and reduce computational cost, the step size may set small, but also as large as possible to have as few as possible number of samples along the ray path to reduce the computational cost. In one example, this is achieved by placing samples unevenly in the most critical positions along the ray path. In one example, the critical positions are determined by positioning of sampling points along the ray to minimize the number of points yet to obtain a ˜maximum rendering accuracy. The variable step_length determines the position of each next sample point as described further below. The information about 3D scalar field in proximity around the ray current position allows making such decisions during the ray casting/traversal on the fly. For instance, the exemplary process can combine such information acquisition with the acquisition of information needed for computations related to the goal of the ray casting procedure (e.g., to get maximum along the ray (MIP) or to computer rendering integral (3DVR etc.) so the same information can be used for computation and for decision about the next step size along the ray. Therefore, such an arrangement does not require code to branch since a single code path gathers information which is used for both: for computations and for decisions about the next step size along the ray. The different ray casting procedures may use different methods to provide/ensure such combination; specifically, as an example, a process to achieve this for three ray casting procedures is described: 1) to obtain a maximum scalar field values along the ray (below MIP), 2) to get an average scalar field values along the ray (below AVG), and 3) to compute rendering integral for given transfer function (below 3DVR).

These three ray casting procedures generally require obtaining interpolation samples along the ray path, specifically: maximum-scalar-field-values-along-ray (MIP) and average-scalar-field-values-along-ray (AVG) need only a single sample for each step while to compute contribution to the rendering integral (3DVR) at each step requires to have x7 samples. To take a single sample requires to execute interpolation. Any interpolation does access/read grids/pixels values around the sampling point. The higher the order of interpolation the more grids it needs to read/access. Tri-linear interpolation requires 2×2×2 pixels/grids, tri-cubic needs 4×4×4 pixels around the sample point. The more grids around sample point acquired the more information it provides about the surrounding 3D scalar field; specifically for these three cases minimums and maximums of 3D scalar field around each sample point. The information about minimums and maximums of 3D-scalar field around each sample point allows the exemplary processes to assess the biggest step size which still provides sufficient accuracy for computation of each of these ray-casting procedures.

Adaptive sampling for MIP: trilinear interpolation is less computationally expensive because it needs to read/access only 2×2×2=8 data grids/pixels around the sample point so it may acquire the minimums and maximums only from x8 pixels around the sample. Tri-cubic is a more expensive interpolation, it needs to read/access 4×4×4=64 data grids/pixels around the sample point so, it may acquire the minimums and maximums from these 64 pixels around the sample point. Tri-cubic interpolation provides more accurate interpolation so, in case of Tri-cubic interpolation the process has a more expensive interpolation but also have a more representative information about the minimums and maximums around the sample point and as a bonus, tri-cubic is more accurate interpolation then trilinear interpolation. Tri-cubic interpolation happens to offer an excellent balance to gather representative information about minimums and maximums around the current sample point and provides a high-quality interpolation. The adaptive sampling method described below significantly offsets the more expensive calculations of tri-cubic interpolation by dramatical reduction the number of samples compared to the usage of trilinear interpolation for the same adaptive mechanism described below.

As an illustration of how the step size/length can be derived from the min/max information around the sample point, an exemplary result of MIP ray-casting procedure is described, which projects the maximum of 3D scalar field along the ray path to the 2D projection plane (screen/viewport). A 2D projection plane (screen) has its own black-gray-white range for its pixels, each pixel brightness can be encoded by some number of bits, for 8-bits it is 2∧8=256 level of grays for 10bits it's 2∧10=1024 etc., the same true for 3D scalar field, each pixel of 3D data the process cast ray through (execute ray-casting) each 3D pixel is presented by some number of bits, let say it is 16bits (2∧16=65536 of gray levels). The screen leveling procedure includes setting the relation/translation how the gray-levels from 3D data can be projected/presented on 2D projection plane (screen). The formula for 8-bits screen and full/complete range of 16-bits 3D data is 256*(pixel3D/65536), if representing/projecting a specific 3D data range [Min3D . . . Max3D] on the 2D screen then formula looks like: 256*((pixel3D-Min3D)/(Max3D-Min3D)), the negative outputs and above 2D screen maximum values saturates to 0 or to 255 accordingly. To assess the distance where the next sampling point may be placed along the ray and to have confidence nothing is missed in between, the following exemplary process (in term of GLSL) includes:
vec2 mnmx; //minimum and maximum of 3D scalar field around the last sample point located inside the middle cell of 4×4×4 3D pixels/grids of the vicinity of the last sample on the ray path. It's acquired during tri-cubic sampling of the last sample.
1 vec HUnx; //min/max screen level: HUnx [0]==Min3D, HUnx [1]==Max3D
max_record [0]=max (max_record [0],sample); //update max_record [0] if the last sample bigger than the current max record
mnmx=max (mnmx,uvec2 (max_record [0])); //it “uplifts” mnmx by already found maximum record (it's a specific speed up for MIP, if maximum of sample's “neighborhood” is below or equal then the current max record (both are translated to 2D screen representation) then step_size==2. Also, the vicinity's minimum is “lifted up” to the current max-record to reduce the max-min delta what increases the step length, this “minimum lifting” may probably go to the claims, it is a generalization of trivial skipping “because there is no maximum inside”).
vec2 pmm=vec2 (mnmx-HUnx [0])/(HUnx [1]-HUnx [0]); //3D mnmx is translated to 2D screen pmm
pmm=max (vec2 (0.0),pmm); pmm=min (vec2 (1.0),pmm); //saturate screen min max levels to [0 . . . 1] range accordingly
float mgn=pmm [1]-pmm [0]; //mgn==screen max-min delta in term of 2D screen pixel
step_length=((2-0.25-(2-0.25)*pow (mgn,1/zoom))+0.25)*edge; //translates the 2D screen max-min delta to the step length.

where “2” is the biggest step length for mgn==0 because the minimum and maximum are acquired from the 4×4×4 surroundings around the last sample. 0.25 is the smallest step length for MIP when mgn==1. “edge” is a step_length’ “suppressor” for ray's edges (near entrance and exit in/out of slab), normally edge==1.0. pow (mgn,1/zoom) sets a non-linear reverse dependence of step length from mgn and 1/zoom defines the non-linearity, it is essentially a quality enhancer.

In summary: the screen max-min delta “mgn” defines the maximum differences seen on a 2D screen if a ray hits or misses the minimum or maximum on its way from the last sample along the ray for a distance==“2”. A similar process can be used for adaptive sampling for AVG ray-casting and various versions fading versions of MIP and AVG ray casting. The fading version of MIP and AVG ray-casting weights each sample by the distance of sample from the origin of the ray. Such adaptive sampling along the ray offers some image enhancement methods. Even a simple average of all samples along the ray acquired by such min/max adaptive method does enhance the 3D areas with higher min-max deltas of scalar field (*). In particular, the sampling density is higher for “turbulent” areas and lower for a “calm” area so, all samples have equal weight but samples for “turbulent” areas are more numerous per unit than samples taken from “calm” areas. Furthermore, each sample can be additionally enhanced by it weighting by the current (max-min) delta or by the inverse of step length. In practical implementation one can use the following weighting procedures (in term of GLSL):
#define AVG_edges_enhancement float (0.5)//AVG edges enhancement (0-a minor, 1-strong edges enhancement) relevant for AVG & FAVG
//1) float weight=(step_length=0.25); /*1) a classic plain average-no edge enhancement (regular samplings 0.25 (twice below Whittaker/Kotelnikov/Nyquist limit==0.5))
//2)float weight=step_length; /*2) a classic plain average (adaptive samplings and weighted by the step length, the same image as #1 but faster due to the adaptive steps sizes)
//3) float weight=1.0; /*3) an adaptive sampling with equal weights (see (*) above); the smaller steps have the same contribution as a bigger one, therefor a moderated edge enhancing takes place because smaller steps correspond to the areas with sharper edges
//4) float weight=(mgn*AVG_edges_enhancement+ (1.0-AVG_edges_enhancement)); /*4) an enhanced #3 with controllable enhance of edges because mgn=max-min deltas. PPP==1.0 corresponds to the case #3
//5) float weight=(mgn*AVG_edges_enhancement+ (1.0-AVG_edges_enhancement))*sample; /*5) an enhanced #3 by the sample value itself (interior of edges filled by the sample’ “substance”; 0)
/*6)*/float weight=(mgn*AVG_edges_enhancement+ (1.0-AVG_edges_enhancement))*sample*sample; /*6) an enhanced #3 by the square sample’ value itself (enhanced interior of edges filling by the sample’ “substance”; 0)//*/
//The number 6 with PPP==0.5 is a default choice, number 1&2 are a regular classic AVG setup to compare with.
   return vec2 (sample*weight, weight); //returns the weighted sample value “sample” and the weight itself “weight”

Adaptive sampling for computing rendering integral (3DVR) represents another case where the exemplary processes described herein works well. For instance, 3DVR requires computing gradients at each sample point. In one example, it takes x7 tri-linear interpolations (one sample on the ray and 6 samples around to compute gradient), and reads/accesses 7*8=56 grids/pixels around the central sample point. During this reading minimum and maximum of sample vicinity are acquired. To describe more specifically how this exemplary method works for 3DVR, a description of how rendering integral is computed for 3DVR ray casting is provided. In particular, for each value of a 3D scalar field (represented by 3D data) corresponds 4 components from transfer function, these 4 components are red, green, blue color, and a 4^{th} component is opacity. Opacity defines what part/portion of current ray-energy is used to contribute to the rendering integral—this portion of energy is distributed among red, green, and blue accordingly and modulated by the dot product of view/light direction and 3D gradient of scalar field at the sample point, the resulting {red green blue} are added/accumulated to the rendering integral and the current ray-energy reduced by the portion of energy used/spent to this contribution. Opacity defines what portion of current ray-energy is spent to contribute to the rendering integral, in fact opacity defines how “noticeable” that sample event is, the “significance” of its contribution to the rendering integral. So, the opacity is the prime “ingredient” effecting the rendering integral computation. Therefore, having maximum and minimums of sample’ vicinity the process may assess the maximum opacity the ray may run into in this “neighborhood” and if such contribution is significant, it is better for this region to have smaller distances between sampling points along the ray path.

The method for adaptive ray-casting for this case follows below (in term of GLSL):
//uvec2 mnmx=the minimum and maximum of 3D scalar field around sample vicinity acquired during gradient computation
1) float mgn=float (mnmx [1]-mnmx [0]), mtp=inversesqrt (mgn+1.0)*(0.5+0.5*RAY_CASTING_PRECISION); //“mtp” has its maximum if mgn==0 and it rapidly declines toward 0 once diversity of all possible gradients increases (it gets farther from the discrete nature of scalar field for +−1 fluctuations)
2) float max_opacity=max (max(GetOpacity(sample), GetOpacity(mnmx [0])),GetOpacity(mnmx [1])); //Obtain Max Opacity around the sample vicinity
3) float dot_product=(abs(dot(gradient, Ray_Direction)))*min (mgn+0.8,1.0); //if mgn==0 then dot_product==0.8 (it's used by Phong lit to get reflective fog for zero gradients regions)

$$4 ) float step\_size \_modulator = ( 1. - max\_opacity * ray\_energy ) ;$$

5) step_length=((mtp+ (1.001357*(mtp+1.0))*zoom_k)*pow (step_size_modulator,14.0)+(0.0625*1.0) *dot_product+0.0625*0.5); //zoom_k—the zoom quality corrector, higher zoom smaller zoom_k=1/sqrt (zoom)

The code above is self-explanatory, yet some clarifications are noted, e.g., regarding point 5):
a) “+0.0625*dot_modified” There are two reasons for this “tiny” disturbance: 1) it slightly randomizes steps across all rays since each ray tends to have an unique profile of gradients so it negates the moiré patterns 2) it increases the sampling density once the ray gets very close to edge along small angle, it starts to make difference once ray gets to distances ˜1/16 to ensure precision for edges (helpful for high zooms or close look for perspective rendering).
b) pow (step_size_modulator, 14.0)—sets an exponential dependence. Once step_size_modulator even slightly below 1 it dramatically reduces the step length and keeps it at maximum for step_size_modulator==1. For example: if the portion of energy to spend==0.02 then the step_size_modulator==0.7536419
c) mtp has its maximum if the minimum and maximum of 3D scalar field around sample vicinity are equal and it rapidly declines for bigger deltas (see correspondent comment in the GLSL code above)
d) so, the maximum step length for mtp==1 would be 1+ (1.001357*(1+1.0))+0.0625+0.0625*0.5==3.096464 and for mtp->0 the maximum step size tends to 1.095107=0+ (1.001357*(0+1.0))+0.0625+0.0625*0.5 and rapidly decreases once it gets in non-zero opacity region, see point (b) above.

With regard to the step length update in this example: the step_length is allowed to get shorter instantly but longer more slowly:
step_length=min (new_step_length, step_length*0.95+0.05*new_step_length); //such step_length “filtering” does contribute substantially to improve the rendering quality for a minor rendering speed impact.
procedure or to use it as a parameter to adjust the computations related to the ray casting procedure.

It will be understood by those skilled in the art that changes in the form and details of the implementations described herein may be made without departing from the scope of this disclosure. In addition, although various advantages, aspects, and objects have been described with reference to various implementations, the scope of this disclosure should not be limited by reference to such advantages, aspects, and objects. Rather, the scope of this disclosure should be determined with reference to the appended claims.

1. An adaptive ray casting system, comprising:
a SIMD processing unit and memory, the memory storing instructions for:
executing a shader;
acquiring information in a vicinity of each sample point along a ray, computing a ray casting process based on the acquired information;
determining a step-length size to the next sample point along the ray; and
rendering at least a portion of an image for display based on the acquired information and the ray casting process.

2. The system of claim 1, wherein the step-length size and/or acquired information is applied to weight each sample contribution to the ray casting process.

3. The system of claim 1, wherein the step-length size and/or acquired information is applied as a parameter to adjust one or more computations associated with the ray casting process.

4. The system of claim 3, wherein the memory further stores instructions for modulating the step-length size or the information used to derive step-length size for adjusting precision of the ray casting process.

5. The system of claim 3, wherein levels of enhancement of the ray casting procedure are driven by the step-length size or by the information used to derive the step-length size.

6. The system of claim 4, wherein a speed requirement for the ray casting procedure establishes the quality/precision tradeoffs modulated by the step-length or by the information used to derive step-length values.

7. The system of claim 1, wherein the acquired information in the vicinity of each of the sample points along the ray randomizes the step-lengths across all rays to negate moiré patterns.

8. The system of claim 1, wherein the vicinity's minimum is raised to the current max-record to reduce the max-min delta what increases the step length.

9. The system of claim 1, wherein the step-length is allowed to get shorter instantly but it's getting longer slowly: step_length=min (new_step_length, step_length*W+(1−W)*new_step_length)//(such step_length “filtering” does contribute substantially to improve the rendering quality for a minor rendering speed impact).

10. The system of claim 1, further comprising rending an image for display based on the acquired information via the ray casting process.

11. A computer implemented method for ray casting, comprising:
at a SIMD processing unit and memory:
executing a shader;
acquiring information in a vicinity of each sample point along a ray, computing a ray casting process based on the acquired information;
determining a step-length size to the next sample point along the ray; and
rendering at least a portion of an image for display based on the acquired information and the ray casting process.

12. A computer readable storage medium comprising instructions for a ray casting process on a SIMD processing unit, the instructions comprising instructions for:
executing a shader;
acquiring information in a vicinity of each sample point along a ray, computing a ray casting process based on the acquired information;
determining a step-length size to the next sample point along the ray; and
rendering at least a portion of an image for display based on the acquired information and the ray casting process.
